(19) United States
(12) Patent Application Publication
(10) Pub. No.: US 2006/0233915 A1
(43) Pub. Date: Oct. 19, 2006

(54) Liquid nutritional product to supplement human milk

(75) Inventors: Gabor Puski, Newburgh, IN (US); James Wayne Hansen, Evansville, IN (US); John Russell Euber, Evansville, IN (US); Yung-Hsiung Lee, Evansville, IN (US)

Correspondence Address: NELSON MULLINS RILEY & SCARBOROUGH, LLP, MERIDIAN, SUITE 1700, 1320 MAIN STREET, COLUMBIA, SC, 29201, US

(73) Assignee: BRISTOL-MYERS SQUIBB COMPANY, PRINCETON, NJ (US)

(21) Appl. No.: 11/106,830

(22) Filed: Apr. 15, 2005

(51) Int. Cl. A23L 1/30

(52) U.S. Cl. 426/72

(57) ABSTRACT

The present invention relates to a commercially sterile liquid nutritional supplement for human milk for feeding infants such as premature or “failure to thrive” infants. The supplement is highly concentrated in order to produce a supplemented human milk that meets the nutritional needs of premature or “failure to thrive” infants in a volume that is well tolerated by the infants. The present invention relates also to methods to support the rapid growth of premature or “failure to thrive” infants by administering the nutritional supplement described herein to such infants.

### FIELD OF INVENTION

The present invention relates to liquid nutrient supplements for infants.

### BACKGROUND

Preterm or premature infants are categorized as those infants born prior to the 37th week of gestation and/or weighing less than 2.5 kilograms (5.5 pounds) at birth. Due to their developmental immaturity and low weight, many of these infants present special nutritional needs. The small stomach and immature sucking and swallowing reflexes in premature infants often hinder adequate oral or nasogastric tube feedings and create a risk of aspiration.

Most premature infants tolerate breast milk, proprietary milk formulas, or specially prepared premature infant formulas. Small premature infants have been successfully tube fed with their own mother's milk, which provides immunologic and nutritional factors that are absent in many commercially available milk formulas. However, breast milk lacks sufficient amounts of certain nutritional components required by low birth weight infants.

“Failure to thrive” (FTT), though a descriptive term and not a definitive clinical diagnosis, is used to describe infants and children whose weight 1) is consistently below the 3rd percentile for their age, 2) progressively decreases to below the 3rd percentile, 3) is 80% of the ideal weight for their height and age, or 4) decreases at an unexpected rate based on the individual's previously defined growth curve, irrespective of whether below the 3rd percentile. FTT may result from a variety of underlying causes, including, but not limited to, decreased nutrient intake caused by cleft lip and/or palate, gastroesophageal reflux, or rumination; malabsorption due to disorders such as celiac disease, cystic fibrosis, or disaccharidase deficiency; impaired metabolism symptomatic of fructose intolerance or classic galactosemia; increased excretion resulting from conditions such as diabetes mellitus and proteinuria; and increased energy requirements of diseases such as bronchopulmonary dysplasia, cystic fibrosis, or hyperthyroidism. Approximately 3-5% of all children admitted to tertiary care centers, and 1% of all children admitted to any hospital, exhibit FTT. Like premature infants, FTT infants have additional nutritional requirements not met by mother's breast milk.

In general, human milk, because of its nutrient composition and immunological properties, is considered an ideal food for infants. Specific bioactive factors in human milk, such as secretory immunoglobulin A (sIgA), lactoferrin, lysozyme, cytokines, oligosaccharides, enzymes and cellular components, are thought to affect the host defense of the infant.

Thus, human milk may modify the infant's gastrointestinal tract in such a way that the barrier to infectious agents is protected and fewer cases of bacterial infection occur. Bacterial infections may lead to the development of necrotizing enterocolitis, a common problem among tube-fed premature infants. While there are tremendous benefits provided by feeding with mother's milk, human milk is typically too low in protein and certain minerals to meet the demands of rapid growth required by many preterm and FTT infants. Additional protein, which is crucial for synthesis of enzymes and hormones as well as growth, and certain minerals, such as calcium and phosphorus, that are needed for appropriate bone development and bone density, must be provided to preterm and FTT infants in the form of human milk nutritional supplements or fortifiers.

Furthermore, the caloric content of human milk typically requires that preterm and FTT infants be fed a volume of milk that is too high to be well tolerated by the infants. Typically, these infants can tolerate total daily feedings of between 100 and 150 ml per kg of the infant's weight. Since the caloric content of human milk is approximately 67 kcal per 100 ml of milk (20 kcal per fluid ounce of milk), and preterm and FTT infants require approximately 120 kcal per kg of weight per day, the volume of human milk that can be tolerated by these infants supplies only about 80 percent of the infant's energy needs. Thus, in order to provide a caloric intake that meets the specialized nutritional needs of preterm and FTT infants in a volume of milk that the infants can tolerate, the caloric content of the human milk should be additionally supplemented with a source of energy such as fats or carbohydrates. For these purposes, nutritional supplements may be designed such that, when dissolved in human milk, the supplemented human milk is capable of delivering to the infant approximately 24 kcal per fluid ounce (approximately 81 kcal per 100 ml), together with amounts of protein and minerals that are higher than those normally present in human milk.

There are presently several commercially available human milk fortifiers, in both powdered and liquid form. While the use of powdered nutrient supplements is an attractive solution for the special nutritional needs of preterm and FTT infants, powdered nutritional supplements are bacteriologically compromised. Generally, powdered nutritional supplements are not manufactured or packaged under sterile conditions.

For example, U.S. Pat. Nos. 6,472,003 and 6,294,206 to Barrett-Reis, et al. relate to a powdered human milk fortifier that is designed to provide nutrition to preterm infants. The product is not, however, processed and packaged so as to yield a sterile product.

Similac Natural Care® (Ross Laboratories, Chicago, Ill.) is the sole available liquid nutritional supplement designed to be combined with human breast milk. While the product is packaged under sterile conditions, the nutrient make-up of this supplement leads to the recommendation that it be added to the mother's milk at a ratio of one to one, thus greatly diluting beneficial components present in the breast milk. Additionally, Similac Natural Care®, as well as other Similac products do not contain both intact and hydrolyzed protein sources and do not meet the calcium requirements of the present invention.

U.S. Pat. Nos. 6,596,302 and 6,495,599 as well as U.S. patent App. Nos. 20020045660, 20020004527 and 20030190363 relate to an infant formula designed to improve the neurological development of preterm infants. The infant formula described in the patents can be a commercially sterile liquid, but does not disclose a particular amount of protein or calcium. The only reference to a particular amount of protein or calcium is in the context of the Similac Products, which, as stated above, do not meet the protein and calcium requirements of the present invention. Further, the patents do not discuss the necessity of having both a soluble and insoluble source of calcium.

Therefore, there remains a need to provide a liquid human milk fortifier that can be produced and maintained under commercially sterile conditions and that can be added to human milk without excessively diluting the milk, and that also provides a daily feeding volume of sufficiently-enhanced nutrients that the infant can tolerate and thrive on.

It has been discovered that by selecting the proper combination of intact protein and hydrolyzed protein as well as the proper combination of soluble and insoluble calcium, a commercially sterile, shelf-stable liquid product can be produced using aseptic processing techniques. The shelf-stable, liquid human milk fortifier can be conveniently combined with human milk to supplement nutrient levels with minimal dilution of human milk.

### SUMMARY OF THE INVENTION

Briefly, therefore, the present invention is directed to a novel concentrated liquid nutritional supplement for combination with human milk. The supplement is prepared in a manner so that it is commercially sterile. Specifically, the composition comprises, per 100 kcal, a protein component present in an amount of at least 2.8 grams, wherein the protein component comprises a source of intact protein and a source of hydrolyzed protein, a fat component, vitamins and minerals, wherein the minerals comprise calcium in an amount of at least about 250 mg, the calcium having a soluble source and an insoluble source. The level of protein together with the vitamins and minerals in the supplement are designed to meet the nutritional needs of preterm infants and infants with failure to thrive.

Certain of the innovative aspects of the invention involve the concentration of nutrients to a level that avoids over-dilution of the human milk to which the supplement is added. The present invention is directed to a composition, as well as a method of using the composition to enhance and support growth of an infant.

The present invention also provides a novel composition and method of supporting rapid growth of an infant by administering to the infant a liquid nutritional supplement comprising, per 100 kcal, a protein component present in an amount of at least 2.8 grams, the protein component having a source of intact protein and hydrolyzed protein; a fat component; vitamins; and minerals, wherein the minerals comprise calcium in an amount of at least about 250 mg, the calcium having a soluble source and an insoluble source.

The composition requires a combination of appropriate ingredients to avoid coagulation and gellation of the highly-concentrated protein present in the supplement. The invention involves the appropriate selection of protein and calcium sources to achieve appropriate levels and concentrations of protein and calcium, while avoiding the problems normally associated with a concentrated nutrient composition. Additionally, the liquid supplement is provided as a commercially sterile product, unlike many powdered products.

For example, the protein source of the nutritional supplement is combination of intact protein and hydrolyzed protein, which promotes the solubility and stability of the supplement. The choice of a source of calcium may also affect the integrity of the composition, thus the present invention includes both soluble and insoluble calcium salts to avoid gelling of the protein and precipitation of calcium.

Among the several advantages found to be achieve by the present invention, is that the use of highly concentrated liquid nutrient supplement results in an bacteriologically safe product that does not unduly dilute the human milk to which it is added.

### DETAILED DESCRIPTION OF THE PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment.

Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

### Definitions

As used herein, the term “nutritional supplement” or “supplement” refers to an additive for improving the nutritional content of certain components of human milk for feeding an infant.

The term “liquid”, as used herein, can encompass any water-based composition such as, for example, a fluid or a gel.

The term “supporting rapid growth”, as used herein, refers to increasing gains in weight, length and/or head circumference at a rate that exceeds the 50th percentile rate of weight gain for a term infant. This gain can be, for example, a weight gain of at least about 15 g/kg/day (intrauterine growth rate), and more preferably, at least about 20 g/kg/day (necessary for “catch-up” growth).

The term “probiotic” means a microorganism that exerts beneficial effects on the health of the host.

The term “prebiotic” means any nondigestible ingredient that stimulates the growth and activity of the beneficial microbiota of the gastrointestinal tract.

The terms “commercial sterility” or “commercially sterile” mean the absence of viable microorganisms with public health significance as well as those of non-health significance capable of reproducing under normal conditions of storage and distribution.

The term “hydrolyzed” refers to a protein that has undergone hydrolysis to some degree. The term can include partial hydrolysis or extensive hydrolysis.

### Invention

In order to avoid excessively diluting the mother's milk, the liquid human milk fortifier should be highly concentrated. The concentration must be such that the liquid fortifier can be mixed with a quantity of human milk that can still provide nutrients at a level comparable to those achieved when the mother's milk is mixed with a powdered fortifier. At such concentrations, protein coagulation, product separation, and gellation that can occur during heat treatment are serious hurdles in developing a commercially acceptable product.

In accordance with the present invention, it has been discovered that a concentrated supplement for addition to human milk which contains certain components in amounts suitable for preterm or FTT infants can be manufactured while avoiding the problems normally associated with the manufacturing of such a concentrated supplement, namely, protein coagulation, protein stability, and maintaining the integrity of the product.

In one embodiment, the present invention encompasses a novel liquid nutritional supplement for addition to human milk comprising, per 100 kcal, a protein component present in an amount of at least 2.8 grams, the protein component having a source of intact protein and a source of hydrolyzed protein; a fat component; vitamins; and minerals, wherein the minerals comprise calcium in an amount of at least about 250 mg, the calcium having a soluble source and an insoluble source.

The protein component of the supplement should be present in an amount suitable to augment the protein supply present in the milk to which the supplement is to be added. In certain embodiments, the protein component is present in an amount of at least 2.9 grams, at least 3.0 grams, at least 3.2 grams, at least 3.4 grams, at least 3.6 grams, at least 3.8 grams, at least 4.0 grams, at least 4.2 grams, at least 4.5 grams, at least 5.0 grams, or at least 5.5 grams per 100 kcal of supplement. In other embodiments, the protein component is present in an amount of about 3.0 grams to about 8.0 grams per 100 kcal of supplement. In other embodiments, the protein component is present in an amount of about 4.0 grams to about 6.0 grams per 100 kcal of supplement. For example, in one embodiment, the protein component is present in an amount of about 5.5 grams per 100 kcal of supplement.

Protein sources suitable for use in the present invention include any protein or nitrogen source for infant consumption. These protein products are commercially available and their commercial sources are known by practitioners of the art. However, in the present invention, a combination of intact and hydrolyzed proteins are used. The hydrolyzed protein may be partially hydrolyzed or extensively hydrolyzed. While not wishing to be bound by this or any other theory, if the protein source is entirely intact protein, the protein may gel during heat treatment. If all the protein is derived from a source that is hydrolyzed, the emulsion may not be stable and may tend to break down during sterilization. Two particular proteins that can be used are a milk protein isolate and a partially hydrolyzed whey protein isolate, such as, for example, BioZate® 3, manufactured by Davisco Foods.

The fat component of the present invention may be present in amounts suitable to enhance infant growth. In certain embodiments of the present invention, the fat component is present in an amount of from about 5.0 grams to about 10.0 grams per 100 kcal of supplement. In other embodiments, the fat component is present in an amount of from about 7.0 grams to about 9.0 grams per 100 kcal of supplement. For example, in one embodiment, the fat component is present in an amount of about 8.8 grams per 100 kcal of supplement.

Most any fat known in the art can be used in the present invention, provided it is suitable for combination with the other components of the supplement. Examples of suitable fat sources typically include high oleic safflower oil, soy oil, fractionated coconut oil, medium chain triglycerides (MCT oil), high oleic sunflower oil, corn oil, canola oil, coconut, palm, and palm kernel oils, marine oil, and cottonseed oil.

The fat source can comprise one or more of these oils. Numerous commercial sources for the fats listed above are readily available and known to one of skill in the art. An emulsifier such as, for example, lecithin, may replace a portion of the fat composition, usually not more than about 2%. In certain aspects of the present invention, the fat component comprises medium chain triglycerides, soybean oil, and lecithin.

Optionally, the fat source may comprise one or more long chain polyunsaturated fatty acids (LCPUFA) such as docosahexaenoic acid (DHA), arachidonic acid (ARA), α-linoleic acid, γ-linoleic acid, linoleic acid, linolenic acid, and eicosapentanoic acid (EPA).

In one embodiment of the present invention, the fat source comprises DHA. In another embodiment of the present invention the fat source comprises ARA. In yet another embodiment the fat source may comprise both DHA and ARA. In this embodiment, the weight ratio of ARA:DHA is typically from about 1:3 to about 9:1. In one embodiment of the present invention, this ratio is from about 1:2 to about 4:1. In yet another embodiment, the ratio is from about 2:3 to about 2:1. In one particular embodiment the ratio is about 2:1.

The effective amount of DHA for use in the present invention is typically from about 3 mg per kg of body weight per day to about 150 mg per kg of body weight per day. In one embodiment of the invention, the amount is from about 6 mg per kg of body weight per day to about 100 mg per kg of body weight per day. In another embodiment the amount is from about 10 mg per kg of body weight per day to about 60 mg per kg of body weight per day. In yet another embodiment the amount is from about 15 mg per kg of body weight per day to about 30 mg per kg of body weight per day.

The effective amount of ARA for use in the present invention is typically from about 5 mg per kg of body weight per day to about 150 mg per kg of body weight per day. In one embodiment of this invention, the amount varies from about 10 mg per kg of body weight per day to about 120 mg per kg of body weight per day. In another embodiment, the amount varies from about 15 mg per kg of body weight per day to about 90 mg per kg of body weight per day. In yet another embodiment, the amount varies from about 20 mg per kg of body weight per day to about 60 mg per kg of body weight per day.

The amount of DHA in infant formulas for use in the present invention typically varies from about 5 mg/100 kcal to about 80 mg/100 kcal. In one embodiment of the present invention it varies from about 10 mg/100 kcal to about 50 mg/100 kcal; and in another embodiment from about 15 mg/100 kcal to about 20 mg/100 kcal. In a particular embodiment of the present invention, the amount of DHA is about 17 mg/100 kcal.

The amount of ARA in infant formulas for use in the present invention typically varies from about 10 mg/100 kcal to about 100 mg/100 kcal. In one embodiment of the present invention, the amount of ARA varies from about 15 mg/100 kcal to about 70 mg/100 kcal. In another embodiment the amount of ARA varies from about 20 mg/100 kcal to about 40 mg/100 kcal. In a particular embodiment of the present invention, the amount of ARA is about 34 mg/100 kcal.

The infant formula supplemented with oils containing DHA and ARA for use in the present invention can be made using standard techniques known in the art. For example, they can be added to the formula by replacing an equivalent amount of an oil, such as high oleic sunflower oil, normally present in the formula. As another example, the oils containing DHA and ARA can be added to the formula by replacing an equivalent amount of the rest of the overall fat blend normally present in the formula without DHA and ARA.

The source of DHA and ARA can be any source known in the art. In an embodiment of the present invention, sources of DHA and ARA are single cell oils as taught in U.S. Pat. Nos. 5,374,567; 5,550,156; and 5,397,591, the disclosures of which are incorporated herein in their entireties by reference thereto. However, the present invention is not limited to only such oils. DHA and ARA can be in natural or refined form.

In one embodiment, the source of DHA and/or ARA is substantially free of EPA. For example, in one embodiment of the present invention the infant formula contains less than about 16 mg EPA/100 kcal; in another embodiment less than about 10 mg EPA/100 kcal; and in yet another embodiment less than about 5 mg EPA/100 kcal. One particular embodiment contains substantially no EPA. Another embodiment is free of EPA in that even trace amounts of EPA are absent from the formula.

Newborn term infants have approximately 75 mg/kg of body iron, 75% of which is in the form of hemoglobin. On average, infants almost triple their blood volume during the first year of life and will require the absorption of 0.4 to 0.6 mg daily of iron during that time to maintain adequate stores. Preterm infants have a lower level of body iron at birth, approximately 64 mg in infants weighing 1 kg. The loss of blood drawn for laboratory tests and the rapid rate of postnatal growth lead to a higher requirement for dietary iron than in term infants—2.0 to 2.5 mg/kg daily to prevent late anemia. See Nutrition Committee, Canadian Paediatric Society (CPS), Canadian Medical Association Journal 144:1451-1454 (1991).

The consequences of iron deficiency include poor weight gain, blood in the stool, malabsorption of nutrients, irritability, decreased attention span, exercise intolerance, and decreased physical activity. When iron deficiency progresses to anemia, performance on tests of psychomotor development is adversely affected for up to at least 3 months despite correction of the anemia with iron therapy. Among infants with severe or chronic iron deficiency, some of these abnormalities may persist indefinitely despite adequate iron therapy. Id.

Therefore, the supplement of the present invention may contain adequate amounts of iron to prevent the onset of anemia in preterm and FTT infants, and avoid developmental abnormalities associated with iron deficiency. In certain embodiments, iron is present in an amount of about 1.0 milligrams to about 8.0 milligrams per 100 kcal of supplement. In other embodiments, iron is present in an amount of about 4.0 milligrams to about 7.0 milligrams per 100 kcal of supplement. For example, in one embodiment, iron is present in an amount of about 6.1 milligrams per 100 kcal of supplement.

Vitamins that may be employed in the present invention include, for example, vitamin A, vitamin D, vitamin E, vitamin K₁, thiamin, riboflavin, vitamin B₆, vitamin B₁₂, niacin, folic acid, panthotenic acid, biotin, and Vitamin C. Mineral nutrients that may be added include, for example, calcium, phosphorus, magnesium, zinc, manganese, copper, sodium, potassium, chloride, iron, selenium, chromium, and molybdenum. In one embodiment of the present invention, shown in Table 1, the mineral nutrients were added in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals that can be added are within the knowledge of a person with ordinary skill in the art who can determine the appropriate amount of vitamins and mineral nutrients following the recommendations of the Committee on Nutrition of the American Academy of Pediatrics or other groups of experts.

It is particularly important for a preterm infant to receive adequate amounts of calcium. The human fetus accrues about 80% of the calcium present at term during the last trimester of pregnancy, and, therefore, in order to achieve similar rates of accretion to promote normal growth and bone mineralization, preterm infants require higher intakes per kilogram body weight of calcium than term infants. Inadequate supplies of calcium in the diet of the preterm infant may lead to osteopenia and increased risk of bone fracture. See American Academy of Pediatrics Committee on Nutrition. “Nutritional Needs of Preterm Infants”. In, Kleinman R E, ed. Pediatric Nutrition Handbook. 4th ed. Elk Grove Village, Ill.; 1998:55-87.

Therefore, the present invention utilizes additional sources of calcium to supplement the calcium found in human breast milk in order to meet the unique needs of the preterm infant. The source of calcium in the nutritional supplement of the present invention is a combination of insoluble and soluble calcium salts. While not wishing to be bound by this or any other theory, if the source of calcium is entirely in insoluble form, the calcium salt may settle out. If the source of calcium is all in soluble form, the calcium may react with the protein present in the supplement and cause the protein to coagulate.

The insoluble calcium salt and the soluble calcium salt may be present in a ratio of from about 1:10 to 10:1. In another embodiment, the ratio of insoluble to soluble calcium salt may be from about 1:4 to 4:1. In yet another embodiment, the ratio of insoluble to soluble calcium salt may be from about 1:2 to 2:1. In a particular embodiment of the present invention, the ratio of insoluble to soluble calcium salt may be about 1:1.

Any insoluble or soluble salt known in the art may be used in the present invention, provided it is suitable for combination with the other components of the supplement. In one embodiment, the insoluble calcium salt comprises calcium phosphate, tribasic. In another embodiment, the soluble calcium salt comprises calcium glycerol phosphate. In another embodiment, the insoluble calcium salt comprises calcium phosphate, tribasic and the soluble calcium salt comprises calcium glycerol phosphate.

In order to provide additional energy to enhance the growth of infants, the liquid nutritional supplement of the present invention may contain at least 25 kcal per fluid ounce. In certain embodiments, the supplement contains from about 30 kcal to about 50 kcal per fluid ounce. In one embodiment, the supplement contains about 43 kcal per fluid ounce.

In the present invention, the liquid nutritional supplement is commercially sterile. In an embodiment, the supplement is aseptically sterilized and packaged during the manufacturing process. The liquid nutritional product of the present invention can be sterilized prior to packaging using an ultra-high temperature (UHT) process that rapidly heats and then cools the product. The processing equipment allows the time (generally 3 to 15 seconds) and temperature (195° to 285° F.) to be tailored to place the least amount of thermal stress on the product while ensuring safety. The sterile product is then filled into a sterilized package and sealed in an aseptic environment.

Compared with traditional retort sterilization, where products are heated in a package for 20 to 50 minutes, this flash heating and cooling process provides a significant reduction in the energy use and nutrient loss associated with conventional sterilization. As a result, an aseptically packaged liquid nutritional supplement retains more nutritional value and exhibits more natural texture, color and taste, all while using less energy.

If methods could be developed to add probiotics to the supplement without hindering the commercial sterility of the product, then any probiotic known in the art may be added. For example, the probiotic may be chosen from the group consisting of Lactobacillus and Bifidobacterium. Alternatively, the probiotic can be Lactobacillus rhamnosus GG.

In certain embodiments, the liquid nutritional supplement of the present invention additionally comprises at least one prebiotic. In this embodiment, any prebiotic known in the art may be added. In a particular embodiment the prebiotic can be selected from the group consisting of fructo-oligosaccharide, gluco-oligosaccharide, galacto-oligosaccharide, isomalto-oligosaccharide, xylo-oligosaccharide and lactulose.

The supplement is added to human milk for administration to an infant, in certain embodiments, at a ratio of supplement:milk between about 1:2 and 1:10. In another embodiment, the ratio of supplement:milk is between about 1:4 and 1:6. In a particular embodiment the ratio of supplement:milk is about 1:5.

Alternatively, the supplement may be administered as a separate oral feeding as part of a daily feeding program where the ratio of total supplement to total human milk or term infant formula is between about 1:2 and 1:10. In another embodiment, the ratio of supplement to milk or formula is between about 1:4 and 1:6. In a particular embodiment, the ratio of supplement to milk or formula is about 1:5. In certain embodiments, the infant is a preterm infant, or an infant with failure to th rive.

An additional benefit of the present invention is that its addition to human milk does not significantly raise the osmolality of the human milk. Osmolality refers to the concentration of osmotically-active particles in an aqueous solution per unit weight of solvent, and is expressed in mOsm/kg. When two solutions employing the same solvent but having different osmolality are contacted through a membrane permeable only to the solvent, the solvent will flow from the low osmolality solution to the high osmolality solution. This phenomenon is particularly pronounced when the dissolved compounds are certain species that are known to have high osmotic activity, such as simple carbohydrates and electrolytes. Other species such as emulsified fats, the form of fat added to nutrient supplements, on the other hand, have low or no osmotic activity.

When a hyperosmolar solution, i.e., an aqueous solution having osmolality higher than that of normal body fluids (approximately 300 mOsm/kg of water), is ingested, certain undesirable gastrointestinal side effects may take place. The hyperosmolar solution may cause an osmotic effect in the stomach and small intestine: water is drawn into the gastrointestinal tract to dilute the concentration of the osmotically-active particles. This influx of water into the gastrointestinal tract may cause diarrhea, nausea, cramping, abdominal distension, regurgitation and vomiting.

Carbohydrates, both complex and simple, can have a high osmotic activity. As a result, typical nutritional supplements that are high in carbohydrates may cause an increase in the osmolality of the supplemented human milk of about 90 to 120 mOsm/kg above normal osmolality levels in unsupplemented milk. In contrast, the present invention may cause an increase in the osmolality of the supplemented human milk of less than about 35 to 40 mOsm/kg. This slightly elevated level of osmolality is acceptable and provides a liquid nutritional supplement that is well-tolerated by infants.

In an embodiment, this benefit is achieved by providing a liquid nutritional supplement having a carbohydrate component of at least about 35% and a fat component of less than about 10%. In an embodiment which is shown in Table 1, below, it can be seen that 22% of the caloric content of the nutritional supplement has a protein source, 76% a fat source, and 2% a carbohydrate source. Thus, an embodiment of the liquid nutritional supplement provides amounts of carbohydrate and fat that do not cause an unacceptable increase in the osmolality of the supplemented human milk and is well-tolerated by infants.

The liquid nutritional supplement of this invention can be manufactured using techniques well-known to those skilled in the art. Manufacturing variations are well-known to those skilled in the nutritional formula art. Various manufacturing techniques are described in detail in the Examples. Generally speaking, two dispersions (protein and mineral) are prepared separately by mixing the protein and minerals with water. An oil blend is prepared containing all oils, any emulsifier, and any fat soluble vitamins. The two dispersions are then mixed together with the oil blend. The resulting mixture is homogenized, sterilized, and packaged. Numerous types of packaging containers are readily available and known to one of skill in the art. Examples of container types typically include packets or sachets which may be manufactured of paper, foil and plastic film, or foil and plastic film coated paper; and ampoules which may be manufactured of plastic, reinforced paper or glass.

The following examples describe various embodiments of the present invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples, all percentages are given on a weight basis unless otherwise indicated.

### EXAMPLE 1

This example illustrates one embodiment of the composition of the nutritional supplement of the present invention. Table 1 illustrates the amount of base nutrients (proteins, fats and carbohydrates), as well as vitamins and mineral nutrients present in 2.33 fl. oz. of liquid nutritional supplement. The caloric content in 2.33 fl. oz. is approximately 100 kcal. To use, 20 ml (0.676 fl. oz.) of the liquid human milk fortifier is added to 100 ml of mother's milk and is then fed to an infant.

TABLE 1
Nutrient Information for Liquid Nutritional Supplement

| | Per 100 Calories | Per Liter |
|---|---|---|
| NUTRIENT, Unit | (2.33 fl. oz.) | (1452 Cal.) |
| Protein, g | 5.5 | 79.86 |
| % of total Calories | 22% | 22% |
| Carbohydrate, g | 0.43 | 6.24 |
| % of total Calories | 2% | 2% |
| Fat, g | 8.8 | 127.8 |
| % of total Calories | 76% | 76% |
| Linoleic acid, mg | 1388 | 20154 |
| α-Linolenic acid, mg | 173.3 | 2516 |
| Vitamin A, IU | 3900 | 56628 |
| Vitamin D, IU | 615 | 8930 |
| Vitamin E, IU | 19 | 276 |
| Vitamin K, μg | 19 | 276 |
| Thiamin (Vitamin B₁), μg | 615 | 8930 |
| Riboflavin (Vitamin B₂), μg | 910 | 13213 |
| Vitamin B₆, μg | 470 | 6824 |
| Vitamin B₁₂, μg | 0.77 | 11.2 |
| Niacin, μg | 12300 | 178596 |
| Folic acid, μg | 105 | 1525 |
| Pantothenic acid, μg | 3100 | 45012 |
| Biotin, μg | 12 | 174 |
| Vitamin C, mg | 50 | 726 |
| Calcium, mg | 380 | 5518 |
| Phosphorus, mg | 215 | 3122 |
| Magnesium, mg | 6.4 | 92.9 |
| Iron, mg | 6.1 | 88.6 |
| Zinc, mg | 3.2 | 46.5 |
| Manganese, μg | 75 | 1089 |
| Copper, μg | 200 | 2904 |
| Sodium, mg | 85 | 1234 |
| Potassium, mg | 150 | 2178 |
| Chloride, mg | 91 | 1321 |

Vitamins (vitamin A, vitamin D₃, vitamin E, vitamin K₁, thiamin, riboflavin, vitamin B₆ hydrochloride, vitamin B₁₂, niacinamide, folic acid, calcium pantothenate, biotin, ascorbic acid), and sources of minerals (calcium phosphate, calcium glycerophosphate, calcium gluconate, sodium citrate, potassium chloride, potassium citrate, potassium phosphate, magnesium phosphate, ferrous sulfate, zinc sulfate, cupric sulfate) may be added to achieve the human milk fortifier composition shown in Table 2 which may be given to infants as a nutritional supplement added to human milk.

TABLE 2
Components of 10,000 Liters of Table 1 Nutrient Supplement
Human Milk Fortifier Base

| | | |
|---|---|---|
| MCT Oil (Medium Cain Triglycerides) | 893.000 | kg |
| Milk Protein Isolate | 455.000 | kg |
| Hydrolyzed Whey Protein Isolate (BioZate ® 3, | 444.000 | kg |
| Davisco Foods) | | |
| Soybean Oil | 383.000 | kg |
| Calcium Glycerol Phosphate | 85.000 | kg |
| Calcium Phosphate, tribasic, | 82.200 | kg |
| Sodium citrate, dihydrate | 33.000 | kg |
| Potassium chloride | 28.000 | kg |
| Potassium phosphate, monobasic | 13.000 | kg |
| Ascorbic acid | 13.000 | kg |
| Mono & diglycerides | 10.550 | kg |
| Lecithin | 6.300 | kg |
| Magnesium phosphate | 4.700 | kg |
| Ferrous sulfate, heptahydrate | 4.400 | kg |
| Tocophenyl Acetate | 4.000 | kg |
| Niacinamide | 2.700 | kg |
| Zinc Sulfate | 1.340 | kg |
| Carrageenan | 1.330 | kg |
| Calcium Pantothenate | 0.700 | kg |
| Vitamin A Palmitate | 0.620 | kg |
| Biotin Trituration 1% | 0.290 | kg |
| Riboflavin | 0.230 | kg |
| Vitamin B₁₂, 0.1% in starch | 0.170 | kg |
| Thiamin Hydrochloride | 0.160 | kg |
| Cholecalciferol concentrate | 0.150 | kg |
| Pyridoxine Hydrochloride | 0.130 | kg |
| Cupric Sulfate | 0.115 | kg |
| Folic Acid | 0.026 | kg |
| Vitamin K₁ liquid | 0.004 | kg |
| Water, q.s. to | 10,296.834 | kg |

| | |
|---|---|
| Potassium hydroxide, pH adjustment as needed | — |
| to pH 6.8-7.0 | |

### EXAMPLE 2

This example illustrates a procedure for manufacturing an embodiment of the liquid human milk fortifier of the present invention. It should be understood that the described procedure is an illustration only and that a person with ordinary skill in the art can develop variations of the procedure or other equivalent procedures that accomplish the same goal.

The composition of an embodiment of the present invention can be found in the listing of components in Table 2. In that embodiment, the protein source comprises milk protein isolate and hydrolyzed whey protein isolate (Biozate® 3 from Davisco Foods). The fat source comprises medium chain triglycerides, soybean oil and lecithin. The illustrated embodiment comprises no carbohydrate source. The minerals added to prepare the liquid fortifier are: sodium citrate, potassium chloride, magnesium phosphate, tricalcium phosphate, ferrous sulfate, potassium phosphate, calcium glycerol phosphate and a trace mineral mix.

A procedure that may be followed to manufacture the liquid human milk fortifier of the present invention comprises the following steps:

1. The protein source, comprising milk protein isolate and hydrolyzed whey protein isolate (Biozate 3), is dispersed in water at room temperature.

2. The pH of the dispersion is adjusted to about 7 with potassium hydroxide.

3. All minerals are dissolved in water, preheated at about 170° F., and the resulting solution is added to the protein dispersion.

4. The pH is readjusted to about 7.

5. The oil blend is preheated to about 160° F., and the monoglycerides, diglycerides, lecithin, and carrageenan were added to the blend.

6. The oil blend is added to the protein/mineral suspension with good mixing.

7. The mixture is heated with direct steam injection to 225° F. for 45 seconds, and then flash cooled to 160° F.

8. The mixture is homogenized twice using a two-stage homogenizer, at a total pressure of 3000 psig, with 2500 psig for the first stage and 500 psig for the second stage.

9. The total solids of the mixture is adjusted to 23.8%.

10. The mixture is aseptically sterilized at 268° F. for 5 seconds at 2000 psig pressure and packaged using a Dole Aseptic canning unit, Model 1305.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

What is claimed is:

1. A commercially sterile liquid nutritional supplement for use in combination with human milk comprising, per 100 kcal:
a protein component present in an amount of at least 2.8 grams, the protein component comprising a source of intact protein and a source of hydrolyzed protein;
a fat component;
vitamins; and
minerals, wherein the minerals comprise calcium in an amount of at least about 250 mg, the calcium comprising a source of soluble calcium and a source of insoluble calcium.

2. The liquid nutritional supplement according to claim 1, wherein the protein component is present in an amount of from about 3.0 grams to about 8.0 grams.

3. The liquid nutritional supplement according to claim 1, wherein the protein component is present in an amount of from about 4.0 grams to about 6.0 grams.

4. The liquid nutritional supplement according to claim 1, wherein the protein component is present in an amount of about 5.5 grams.

5. The liquid nutritional supplement according to claim 1, wherein the ratio of insoluble:soluble calcium is from about 1:10 to 10:1.

6. The liquid nutritional supplement according to claim 1, wherein the ratio of insoluble:soluble calcium is from about 1:4 to 4:1.

7. The liquid nutritional supplement according to claim 1, wherein the ratio of insoluble:soluble calcium is from about 1:2 to 2:1.

8. The liquid nutritional supplement according to claim 1, wherein the ratio of insoluble:soluble calcium is about 1:1.

9. The liquid nutritional supplement according to claim 1, wherein the fat component is present in an amount of from about 5.0 grams to about 10.0 grams.

10. The liquid nutritional supplement according to claim 1, wherein the fat component comprises DHA and/or ARA.

11. The liquid nutritional supplement according to claim 10, wherein the ratio of ARA:DHA is from about 1:3 to about 9:1.

12. The liquid nutritional supplement according to claim 10, wherein the DHA is present in an amount of between about 3 mg per kg of body weight per day to about 150 mg per kg of body weight per day and/or the ARA is present in an amount of between about 5 mg per kg of body weight per day to about 150 mg per kg of body weight per day.

13. The liquid nutritional supplement according to claim 1, wherein the minerals are selected from the group consisting of iron calcium, phosphorus, magnesium, zinc, manganese, copper, sodium, potassium, chloride, selenium, chromium, and molybdenum.

14. The liquid nutritional supplement according to claim 13, wherein iron is present in an amount from about 1.0 milligrams to about 8.0 milligrams per 100 kcal of supplement.

15. The liquid nutritional supplement according to claim 1, wherein the supplement contains at least 25 kcal per fluid ounce.

16. The liquid nutritional supplement according to claim 1, wherein the supplement contains from about 30 to about 50 kcal per fluid ounce.

17. The liquid nutritional supplement according to claim 1, wherein the supplement contains about 43 kcal per fluid ounce.

18. The liquid nutritional supplement according to claim 1, wherein the supplement additionally comprises at least one probiotic.

19. The liquid nutritional supplement according to claim 18, wherein the probioic is selected from the group consisting of Lactobacillus, Bifidobacterium, and combinations thereof.

20. The liquid nutritional supplement according to claim 18, wherein the probiotic is Lactobacillus rhamnosus GG.

21. The liquid nutritional supplement according to claim 1, wherein the supplement additionally comprises at least one prebiotic.

22. The liquid nutritional supplement according to claim 21, wherein the prebiotic is selected from the group consisting of fructo-oligosaccharide, gluco-oligosaccharide, galacto-oligosaccharide, isomalto-oligosaccharide, xylo-oligosaccharide and lactulose.

23. The liquid nutritional supplement according to claim 1, additionally comprising a carbohydrate component.

24. The liquid nutritional supplement according to claim 23, wherein the carbohydrate component comprises at least about 35% by weight of the total calories and the fat component comprises less than about 10% by weight of the total calories.

25. A composition for administering to infants comprising the liquid nutritional supplement according to claim 1 and human milk.

26. The composition according to claim 25, wherein the ratio of supplement:human milk is between about 1:2 and 1:10.

27. The composition according to claim 25, wherein the ratio of supplement:human milk is between about 1:4 and 1:6.

28. The composition according to claim 25, wherein the ratio of supplement:human milk is about 1:5.

29. The composition according to claim 25, additionally comprising a carbohydrate component.

30. The composition according to claim 29, wherein the carbohydrate component comprises at least about 35% by weight of the total calories and the fat component comprises less than about 10% by weight of the total calories.

31. The composition according to claim 30, wherein the osmolality of the supplemented human milk is raised less than about 75 mOsm/kg over that of unsupplemented human milk.

32. The composition according to claim 30, wherein the osmolality of the supplemented human milk is raised less than about 50 mOsm/kg over that of unsupplemented human milk.

33. The composition according to claim 30, wherein the osmolality of the supplemented human milk is raised less than about 35 mOsm/kg over that of unsupplemented human milk.

34. A commercially sterile liquid nutritional supplement for use in combination with human milk comprising:
a protein component, the protein component comprising a source of intact protein and a source of hydrolyzed protein;
a fat component;
vitamins;
minerals; and
wherein the supplement contains at least 25 kcal per fluid ounce.

35. The liquid nutritional supplement according to claim 34, wherein the supplement contains between about 30 and 50 kcal per fluid ounce.

36. The liquid nutritional supplement according to claim 34, wherein the supplement contains about 43 kcal per fluid ounce.

37. The liquid nutritional supplement according to claim 34, wherein the protein component comprises a source of intact protein and a source of hydrolyzed protein.

38. The liquid nutritional supplement according to claim 34, wherein the minerals include a soluble source of calcium and an insoluble source of calcium.

39. A method of supporting growth of an infant by administering to the infant a commercially sterile liquid nutritional supplement comprising, per 100 kcal:
a protein component present in an amount of at least 2.8 grams, the protein component having a source of intact protein and a source of hydrolyzed protein;
a fat component;
vitamins; and
minerals, wherein the minerals comprise calcium in an amount of at least about 250 mg, the calcium having a soluble source and an insoluble source.

40. The method according to claim 39, wherein the supplement is added to human milk for administration to the infant.

41. The method according to claim 40, wherein the ratio of supplement:human milk is between about 1:2 and 1:10.

42. The method according to claim 40, wherein the ratio of supplement:human milk is about 1:5.

43. The method according to claim 39, wherein the infant is a preterm infant or a failure to thrive infant.

44. A kit for packaging the liquid nutritional supplement of claim 1, the kit comprising a commercially sterilized package, filled with the nutritional supplement of claim 1, wherein the supplement is filled into the commercially sterilized package and sealed in an aseptic environment.
